(19) United States
(12) Patent Application Publication
(10) Pub. No.: US 2013/0207795 A1
(43) Pub. Date: Aug. 15, 2013

(54) VEHICULAR BURGLAR PROOF SYSTEM AND METHOD

(71) Applicant: YUH-SHYING GAU, Tu-Cheng (TW)

(72) Inventor: YUH-SHYING GAU, Tu-Cheng (TW)

(73) Assignee: HON HAI PRECISION INDUSTRY CO., LTD., Tu-Cheng (TW)

(21) Appl. No.: 13/396,599

(22) Filed: Feb. 15, 2012

(51) Int. Cl. B60R 25/04; B60R 25/10

(52) U.S. Cl. 340/426.11; 340/426.18

(57) ABSTRACT

A burglar proof system for a vehicle is provided. The burglar proof system includes an observation module, a portable dashboard, a dashboard docking station, and an engine control module. When the portable dashboard is connected to the dashboard docking station, the authenticity of a portable dashboard is determined. The engine control module can only operate when the portable dashboard identification is validated. The dashboard docking station transmits a validation failure warning message to a server if a portable dashboard is not authenticated. When the portable dashboard is not coupled with the dashboard docking station, the engine control module is disabled, and the observation module transmits locational information to the server in response to any movement of the vehicle determined according to onboard sensors. The disclosure further provides a burglar proof method for a vehicle.

### BACKGROUND

1. Technical Field

The present disclosure relates to a burglar proof system and a burglar proof method, and particularly to a burglar proof system and a burglar proof method for a vehicle.

2. Description of Related Art

The burglar proof systems of related art for vehicles such as motorcycles and cars merely provide simple mechanisms such as lock assemblies, and vehicles with such systems can be stolen relatively easily, to the great inconvenience of the user. In addition, since such systems are incapable of providing the location of the vehicle, they cannot assist in finding the vehicle when abandoned.

What is needed, therefore, is a vehicular burglar proof system capable of overcoming the limitations described.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a schematic diagram of an embodiment of a vehicular burglar proof system of the present disclosure.

FIG. 2 is a block diagram of an embodiment of the vehicular burglar proof system shown in FIG. 1.

FIG. 3A is a block diagram of an embodiment of the movement identification unit shown in FIG. 2.

FIG. 3B is a curve graph including the curves of an acceleration value and an engine speed referenced by the identification unit shown in FIG. 3A

FIGS. 4A/4B is a flowchart of a first embodiment of a vehicular burglar proof method implemented through the vehicular burglar proof system shown in FIG. 2.

FIG. 5 is a flowchart of an embodiment of step S1110 of FIGS. 4A/4B implemented through the vehicular burglar proof system shown in FIG. 3A.

FIG. 6 is a flowchart of a second embodiment of a vehicular burglar proof method implemented through the vehicular burglar proof system shown in FIG. 2.

FIG. 7 is a flowchart of a third embodiment of a vehicular burglar proof method implemented through the vehicular burglar proof system shown in FIG. 2.

### DETAILED DESCRIPTION

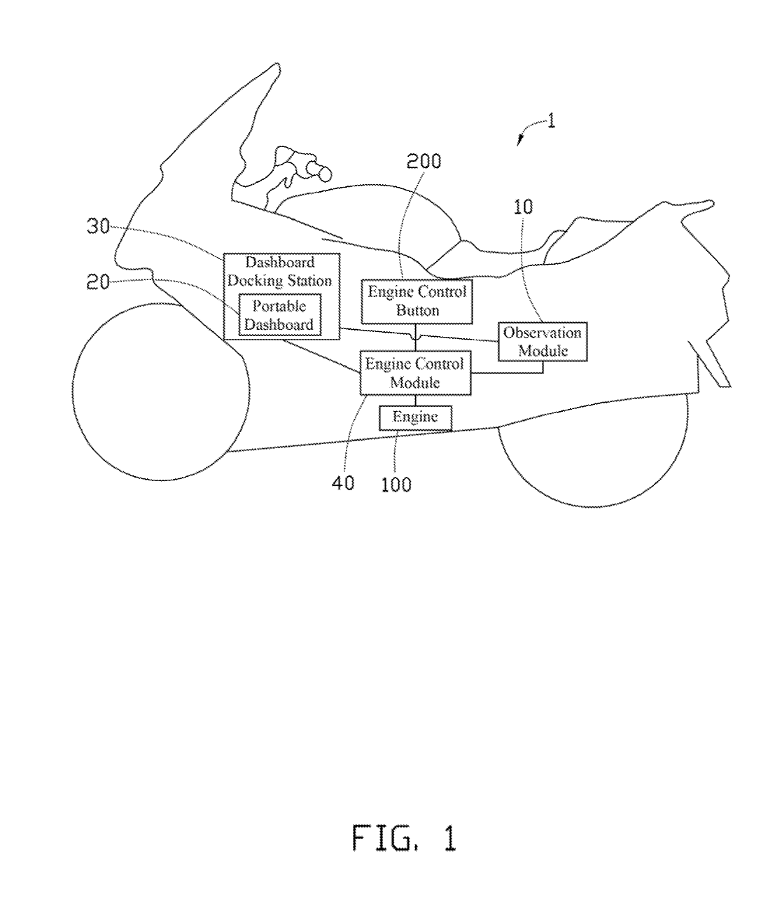

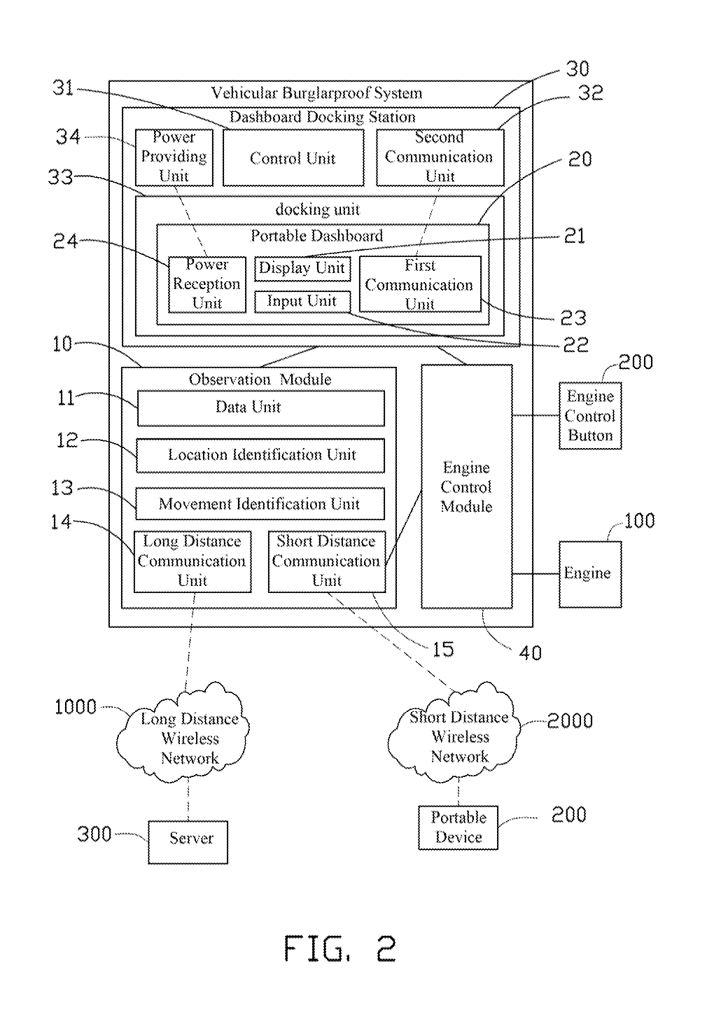

FIG. 1 is a schematic diagram of a vehicular burglar proof system of the present disclosure. In the illustrated embodiment, the vehicular burglar proof system is applied to a motorcycle 1. In other embodiments, the vehicular burglar proof system can be applied to any other type of vehicles such as cars. The vehicular burglar proof system includes an observation module 10, a portable dashboard 20, a dashboard docking station 30, and an engine control module 40 which operates an engine 100 of the motorcycle 1 by, for instance, starting/stopping the engine 100 and/or adjusting the speed of the engine 100. In the illustrated embodiment, the observation module 10 is disposed inside the motorcycle 1 for example under a seat of the motorcycle 1. In addition, an engine control button 200 is coupled to the engine control module 40. The engine control button 200 can be actuated to start/stop the engine 100 manually. In other embodiments, the observation module 10 can be disposed in other ways. For instance, the observation module 10 can be disposed inside the dashboard docking station 30. The engine control button 200 is not fundamental.

FIG. 2 is a block diagram of an embodiment of the vehicular burglar proof system shown in FIG. 1. The observation module 10 includes a data unit 11, a location identification unit 12, a movement identification unit 13, a long distance wireless communication unit 14, and a short distance wireless communication unit 15. The data unit 11 stores the working parameters of the vehicle and all data relating thereto such as data emanating from the location identification unit 12 and from the movement identification unit 13. In the illustrated embodiment, the location identification unit 12 is a GPS (Global Positioning System) receiver which is capable of producing a location information Iv (not shown) representing a latitude, a longitude, and/or an elevation of the motorcycle 1. In other embodiments, the location identification unit 12 can be other type of location identification devices such as WPS (Wi-Fi Positioning System) receiver, while the location information Iv can include other type of locational data of the motorcycle 1. The movement identification unit 13 is capable of producing information Im (not shown) which represents any significant movement of the motorcycle 1. The long distance wireless communication unit 14 is capable of communicating with a server 300 through a long distance wireless network 1000 implemented according to a telecommunication standard such as GSM (Global System for Mobile Communications) or Wi-Fi. The short distance wireless communication unit 15 is capable of communicating with a portable device 400 through a short distance wireless network 2000 implemented according to a telecommunication standard such as BLUETOOTH.

In the illustrated embodiment, the working parameters stored in the data unit 11 can be modified through the portable device 400 by receiving an input from the portable device 400 and modifying the parameters according to the input. In other embodiments, the working parameters can be modified through other type of electronic devices such as computers, while the connection between the observation module 10 and the electronic device can be other type of interfaces such as a wired interface(s). The server 300 can transmit a location inquiry instruction to the observation module 10 in response to a location requirement of the portable device 400. The observation module 10 transmits the location information Iv to the server 300 in response to the location inquiry instruction, such that the server 300 can reply to the location requirement of the portable device 400 according to the location information Iv. As a result, the location of the motorcycle 1 can always be provided to the user of the motorcycle 1 through the portable device 400 by, for instance, displaying a map including an icon representing the location of the motorcycle 1 on a display of the portable device 400.

The portable dashboard 20 is a portable electronic device including a display unit 21, an input unit 22, a first communication unit 23, and a power reception unit 24. The display unit 21 displays a number of parameters of the motorcycle 1 such as speed, engine oil pressure, and mileage accumulated. In the illustrated embodiment, the display unit 21 is a touchscreen, and the input unit 22 is a touch sensitive mechanism of the display unit 21. The dashboard docking station 30 is disposed on a front portion of the motorcycle 1. The dashboard docking station 30 includes a control unit 31, a second communication unit 32, a docking unit 33, and a power providing unit 34. In the illustrated embodiment, the second communication unit 32 is a RFID (radio-frequency identification) chip including a portable dashboard identification Ip (not shown), and the first communication unit 23 of the portable dashboard 20 is a RFID reader. In other embodiments, the second communication unit 32 and the first communication unit 23 can be other type of devices implemented according to other telecommunication standards. For example, the second communication unit 32 and the first communication unit 23 can be a BLUETOOTH transmitter and a BLUETOOTH receiver, respectively. The second communication unit 32 and the first communication unit 23 can be a pair of electric connector which can be selectively electrically connected with each other. In addition, the portable dashboard identification Ip can be included in other portion of the dashboard docking station 30, for example, a storage device such as a memory.

The portable dashboard 20 can be selectively coupled to the dashboard docking station 30 and removed therefrom. In the illustrated embodiment, the docking unit 33 of the dashboard docking station 30 is a slot for receiving the portable dashboard 20. The portable dashboard 20 is coupled to the dashboard docking station 30 by insertion into the docking unit 33. In other embodiments, the docking unit 33 can be other type of mechanism or devices such as a connector or a plug or socket or conducting wire for connecting the portable dashboard 20 and the dashboard docking station 30.

When the portable dashboard 20 is coupled to the dashboard docking station 30, the dashboard docking station 30 receives the portable dashboard identification Ip of the portable dashboard 20 through the second communication unit 32, and the control unit 31 seeks to determine the validity of the portable dashboard identification Ip. If the portable dashboard identification Ip is valid, the control unit 31 enables the engine control module 40, such that the engine 100 can be controlled through the engine control module 40; otherwise, the control unit 31 enables the observation module 10 to transmit a validation failure warning message Mv (not shown) to the server 300, such that the server 300 can inform a client such as the user of the motorcycle 1, through, for example, the portable device 400 or other electronic devices capable of communicating with the server 300. The validation failure warning message Mv represents the likelihood of irregular attempt to start the engine 100.

When the portable dashboard 20 is not coupled to the dashboard docking station 30, the observation module 10 is capable of transmitting an exceptional movement warning message Me (not shown) including the location information Iv to the server 300 in response to a movement of the motorcycle 1 determined according to the movement information Im. In the illustrated embodiment, the removal of the portable dashboard 20 from the dashboard docking station 30 is detected by the dashboard docking station 30. When the portable dashboard 20 is removed, the control unit 31 stops the engine 100 through the engine control module 40, and disables the engine control module 40.

In the illustrated embodiment, the display unit 21 displays the one or more states of the motorcycle 1 only when the portable dashboard identification Ip is valid; otherwise, the statuses of the motorcycle 1 cannot be viewed. In other embodiments, the display unit 21 can display information as to the status of the motorcycle 1 or otherwise when the portable dashboard identification Ip is determined invalid. In addition, the display unit 21 can display the statuses of the motorcycle 1 only when the portable dashboard identification Ip is valid and a password inputted through the input unit 22 of the portable dashboard 20 matches a boot password.

In the illustrated embodiment, when the long distance wireless communication unit 14 of the observation module 10 receives an engine stopping instruction from the server 300, the observation module 10 acts on the engine control module 40 to stop the engine 100, and disables the engine control module 40. When the engine control module 40 is disabled in response to receiving the engine stopping instruction, the engine control module 40 can be enabled again only when a password which is input through the input unit 22 of the portable dashboard 20 in fact matches an unlock password. Consequently, a thief riding the motorcycle away will not be able to travel very far.

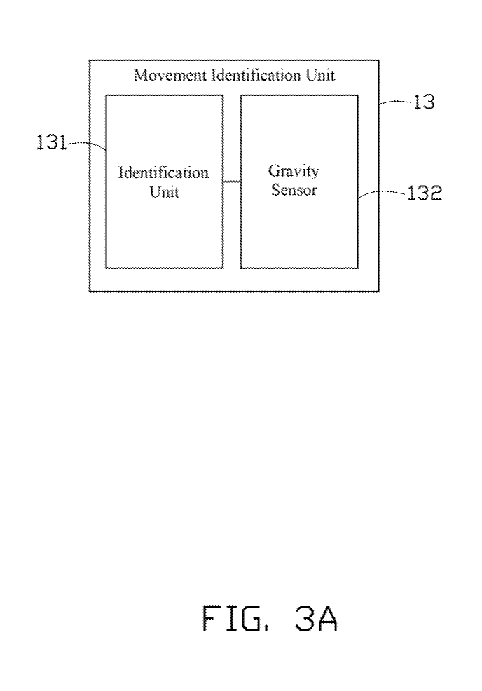

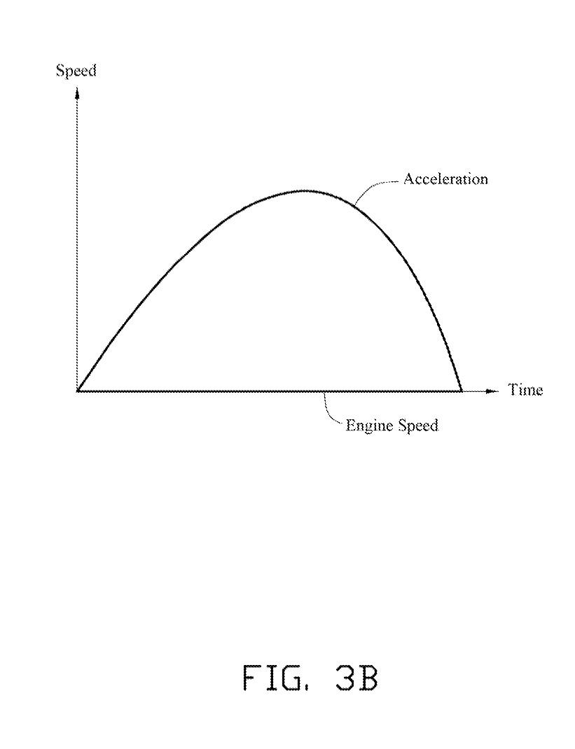

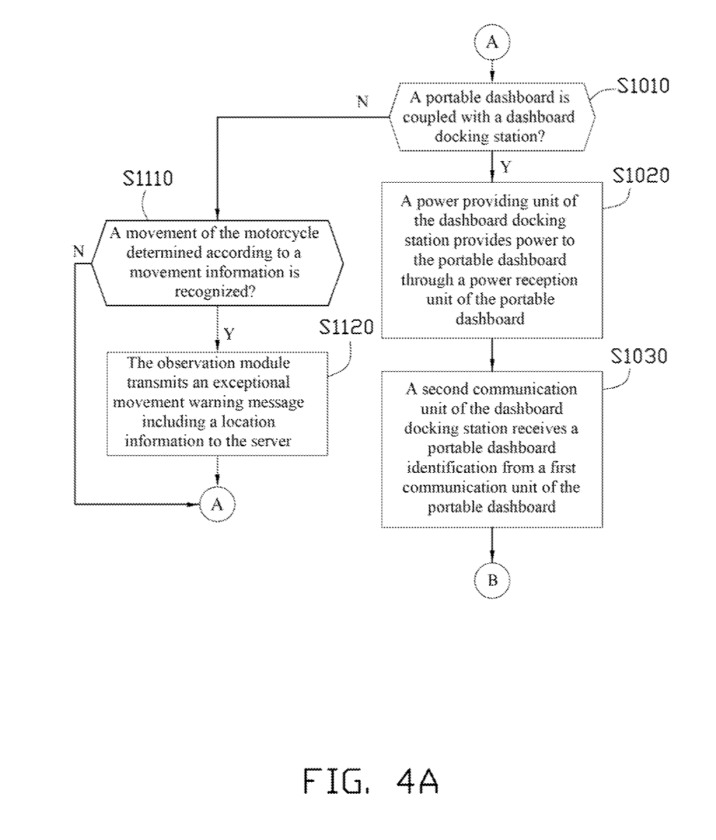

FIG. 3A is a block diagram of an embodiment of the movement identification unit 13 shown in FIG. 2. The movement identification unit 13 of the observation module 10 includes an identification unit 131 and a gravity sensor 132. The gravity sensor 132 produces an inertia information Ii (not shown). FIG. 3B is a curve graph including the curves of an acceleration value and the speed of the engine 100 referenced by the identification unit 131 shown in FIG. 3A. The identification unit 131 produces the acceleration value according to the inertia information Ii, and seeks to compare the acceleration value with the speed of the engine 100 (if the engine is working) received from, for example, the engine control module 40. When there is a difference between the acceleration value and the suggested speed of the engine 100 and the difference exceeds a predetermined value, a movement of the motorcycle 1 is recognized, and the observation module 10 transmits the exceptional movement warning message Me including the location information Iv to the server 300, such that the server 300 can inform the user of the motorcycle 1 as the client through, for example, the portable device 400 or other electronic devices capable of communicating with the server 300. The exceptional movement warning message Me represents the likelihood of irregular attempt to move the motorcycle 1 by, for instance, towing the motorcycle 1 along the road or lifting it by a crane or otherwise.

The power reception unit 24 of the portable dashboard 20 corresponds to the power providing unit 34 of the dashboard docking station 30. When the power reception unit 24 couples with the power providing unit 34, the power providing unit 34 provides power to the portable dashboard 20 through the power reception unit 24. In the illustrated embodiment, the power reception unit 24 and the power providing unit 34 are power coils. In other embodiments, the power reception unit 24 and the power providing unit 34 can be, for example, a plug and a socket or other type of device for supplying power.

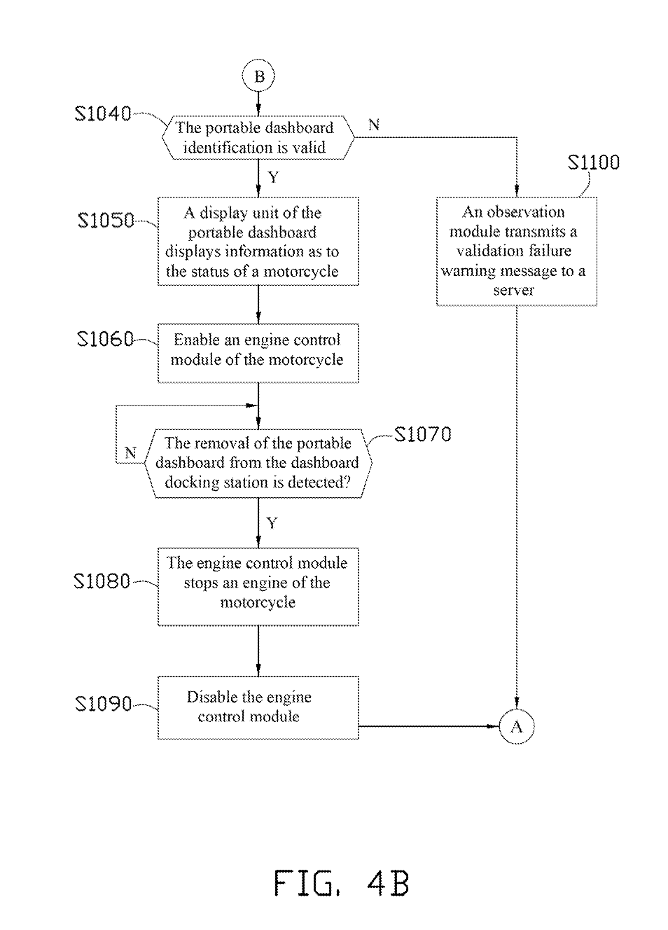

FIGS. 4A/4B is a flowchart of a first embodiment of a vehicular burglar proof method implemented through the vehicular burglar proof system shown in FIG. 2. The vehicular burglar proof method of the present disclosure follows. Depending on the embodiment, additional steps may be added, others removed, and the ordering of the steps may be changed.

In step S1010, a determination is made as to whether the portable dashboard 20 is coupled with the dashboard docking station 30. If coupled, step S1020 is implemented; otherwise, step S1110 is implemented.

In step S1020, the power providing unit 34 of the dashboard docking station 30 is enabled to provide power to the portable dashboard 20 through the power reception unit 24 of the portable dashboard 20 when the power reception unit 24 couples with the power providing unit 34.

In step S1030, the second communication unit 32 of the dashboard docking station 30 is enabled to receive the portable dashboard identification Ip from the first communication unit 23 of the portable dashboard 20.

In step S1040, the validity of the portable dashboard identification Ip is determined. If determined to be valid, step 1050 is implemented; otherwise, step S1100 is implemented. In the illustrated embodiment, the display unit 21 of the portable dashboard 20 does not display any information when the portable dashboard identification Ip is deemed invalid. In other embodiments, the display unit 21 can display some information when the portable dashboard identification Ip is deemed invalid.

In step S1050, the display unit 21 of the portable dashboard 20 is enabled to display information as to the status of the motorcycle 1. In other embodiments, the display unit 21 can display the statuses of the motorcycle 1 only when the portable dashboard identification Ip is valid and a password inputted through the input unit 22 of the portable dashboard 20 matches a boot password.

In step S1060, the engine control module 40 of the motorcycle 1 is enabled, such that the engine 100 of the motorcycle 1 can be controlled through the engine control module 40.

In step S1070, the removal of the portable dashboard 20 from the dashboard docking station 30 is immediately detected. If removed, step S1080 is implemented, step S1070 is maintained until the removal takes place.

In step S1080, the engine control module 40 is enabled to stop the engine 100.

In step S1090, the engine control module 40 is disabled.

In step S1100, the observation module 10 transmits the validation failure warning message My to the server 100.

In step S1110, a movement of the motorcycle 1 is determined according to the movement information Im. If a movement is recognized, step S1120 is implemented, otherwise, step S1010 is implemented.

In step S1120, the observation module 10 is enabled to transmit an exceptional movement warning message Me including the location information Iv to the server 100.

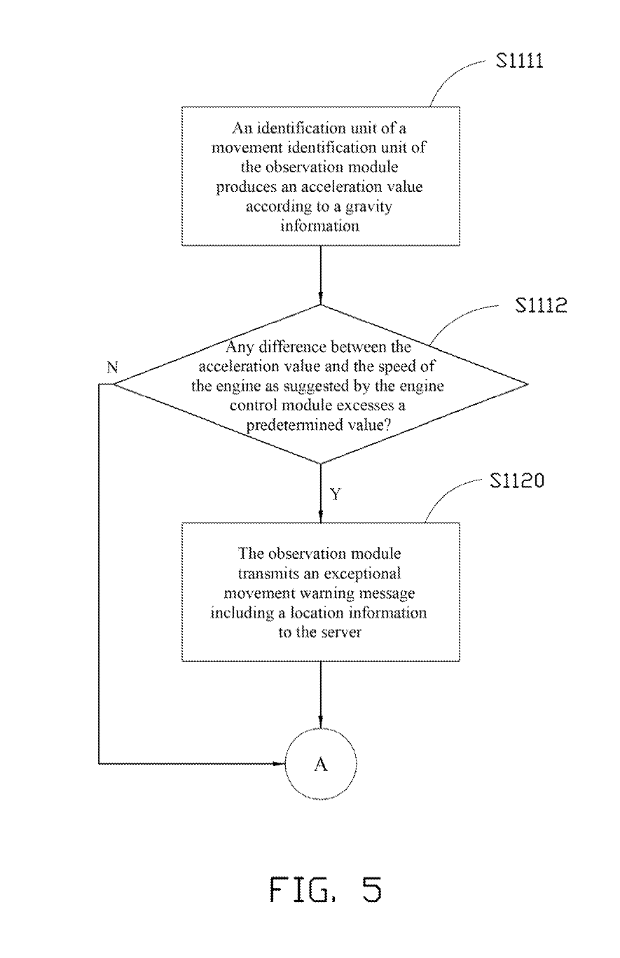

FIG. 5 is a flowchart of an embodiment of step S1110 of FIGS. 4A/4B implemented through the vehicular burglar proof system shown in FIG. 3A. The vehicular burglar proof method of the present disclosure follows. Depending on the embodiment, additional steps may be added, others removed, and the ordering of the steps may be changed.

In step S1111, the identification unit 131 of the movement identification unit 13 of the observation module 10 produces an acceleration value according to the inertia information Ii produced by the gravity sensor 132 of the movement identification unit 13.

In step S1112, any difference between the acceleration value and the speed of the engine 100 as suggested by the engine control module 40 is determined. If the difference exceeds a predetermined value, step S1120 is implemented; otherwise, step S1010 is implemented.

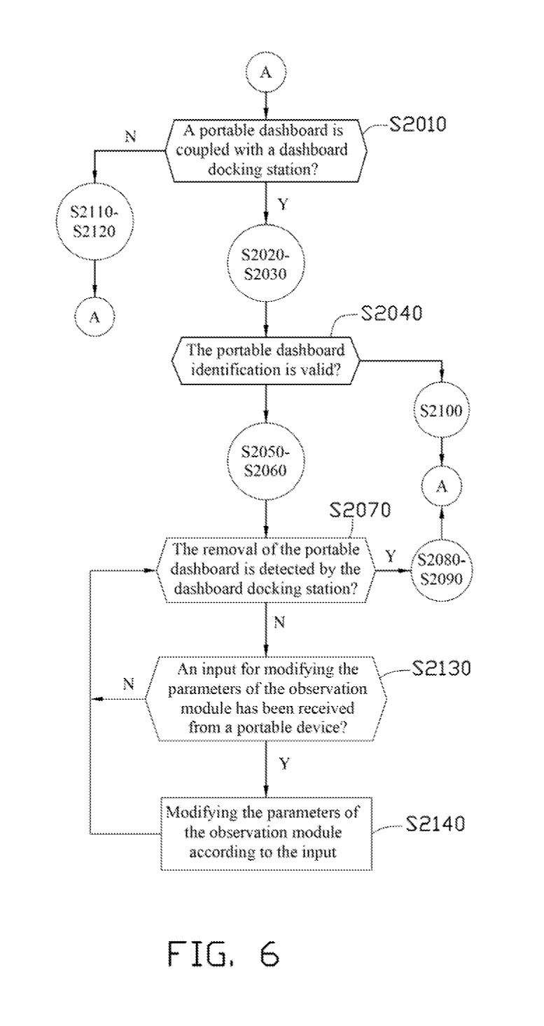

FIG. 6 is a flowchart of a second embodiment of a vehicular burglar proof method implemented through the vehicular burglar proof system shown in FIG. 2. The vehicular burglar proof method of the present disclosure follows. Depending on the embodiment, additional steps may be added, others removed, and the ordering of the steps may be changed.

Steps S2010-S2060 and S2080-S2120 of the second embodiment are respectively equivalent to S1020-S1060 and S1080-S1120, of FIGS. 4A/4B, as detailed above, and will not be repeated hereinafter.

In step S2070, the dashboard docking station 30 detects the removal of the portable dashboard 20. If a removal takes place, step S2080 is implemented; otherwise, step S2130 is continued.

In step S2130, a determination is made as to whether an input for modifying the parameters of the observation module 10 has been received from the portable device 400. If an input has been received, step S2140 is implemented; otherwise, step S2070 is implemented.

In step S2140, the parameters of the observation module 10 are modified according to the input.

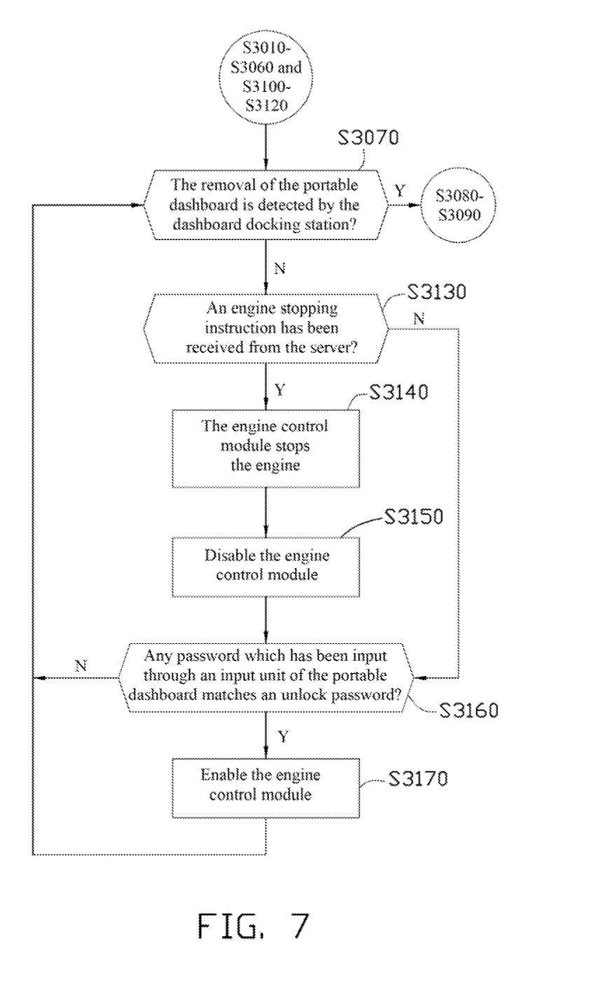

FIG. 7 is a flowchart of a third embodiment of a vehicular burglar proof method implemented through the vehicular burglar proof system shown in FIG. 2. The vehicular burglar proof method of the present disclosure follows. Depending on the embodiment, additional steps may be added, others removed, and the ordering of the steps may be changed.

Steps S3010-S3060 and S3080-S3120 are respectively equivalent to S1010-S1060 and S1080-S1120, of FIGS. 4A/4B, as detailed above, and will not be repeated hereinafter.

In step S3070, the dashboard docking station 30 detects the removal of the portable dashboard 20. If a removal takes place, step S3080 is implemented; otherwise, step S3130 is implemented.

In step S3130, a determination is made as to whether an engine stopping instruction has been received from the server 100. If such an instruction has been received, step S3140 is implemented; otherwise, step S3160 is implemented.

In step S3140, the engine control module 40 stops the engine 100 of the motorcycle 1.

In step S3150, the engine control module 40 is disabled.

In step S3160, a determination is made as to whether any password which has been input through the input unit 22 of the portable dashboard 20 matches an unlock password. If a match is found, step S3170 is implemented; otherwise, step S3070 is implemented.

In step S3170, the engine control module 40 is enabled.

The vehicular burglar proof system and the vehicular burglar proof method provide vehicle security through transmitting the validation failure warning message My and the exceptional movement warning message Me to the server 300, such that a user of the motorcycle 1 as the client can be informed by the server 300 when an irregular attempt to start the engine 100 is recognized or when the motorcycle 1 is being irregularly moved. In addition, since the server 100 can track the location of the motorcycle 1 through the location information Iv in the exceptional movement warning message Me, the current location of the motorcycle 1 can be easily determined at any time.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

1. A burglar proof system for a vehicle, comprising:
an observation module comprising a location identification unit, a movement identification unit, and a wireless communication unit, wherein the location identification unit produces a location information, the movement identification unit produces a movement information, the wireless communication unit communicates with a server through a wireless network;
a portable dashboard comprising a display unit and a first communication unit, wherein the display unit displays one or more statuses of the vehicle, the first communication unit transmits a portable dashboard identification; and
a dashboard docking station comprising a control unit and a second communication unit;
wherein when the portable dashboard is coupled with the dashboard docking station, the dashboard docking station receives the portable dashboard identification through the second communication unit of the dashboard docking station, and the control unit of the dashboard docking station determines the validity of the portable dashboard identification; when the portable dashboard identification is valid, the control unit enables an engine control module operating an engine of the vehicle; and
wherein when the portable dashboard is not coupled with the dashboard docking station, the observation module transmits an exceptional movement warning message comprising the location information to the server in response to a movement of the vehicle determined according to the movement information.

2. The burglar proof system of claim 1, wherein when the portable dashboard identification is invalid, the control unit enables the observation module to transmit a validation failure warning message to the server.

3. The burglar proof system of claim 1, wherein the observation module further comprises a data unit comprising parameters of the observation module, the wireless communication unit comprises a long distance wireless communication unit and a short distance wireless communication unit, the long distance wireless communication unit communicates with the server, the short distance wireless communication unit communicates with a portable device, the parameters of the observation module is modified through the portable device.

4. The burglar proof system of claim 1, wherein when the removal of the portable dashboard from the dashboard docking station is detected, the control unit of the dashboard docking station stops the engine through the engine control module and disables the engine control module.

5. The burglar proof system of claim 1, wherein the observation module enables the engine control module to stop the engine of the vehicle and disables the engine control module in response to an engine stopping instruction received from the server.

6. The burglar proof system of claim 5, wherein the portable dashboard further comprising an input unit, the control unit of the dashboard docking station receives a password inputted through the input unit, and enables the engine control module when the password matches an unlock password.

7. The burglar proof system of claim 1, wherein the display unit of the portable dashboard displays the one or more statuses of the vehicle when the portable dashboard identification is valid, and not displays at least one of the statuses of the vehicle when the portable dashboard identification is invalid.

8. The burglar proof system of claim 1, wherein the one or more statuses of the vehicle includes at least one of speed, engine oil pressure, and accumulated mileage of the vehicle.

9. The burglar proof system of claim 1, wherein the first communication unit is a RFID (radio-frequency identification) reader, the second communication unit is a RFID chip comprising the portable dashboard identification.

10. The burglar proof system of claim 1, wherein the dashboard docking station further comprises a first power coil, the portable dashboard further comprises a second power coil, when the second power coil couples the first power coil, the first power coil provides power to the portable dashboard through the second power coil.

11. A burglar proof method for a vehicle, comprising:
a vehicle with an observation module, a portable dashboard, and a dashboard docking station, wherein the observation module produces a location information and a movement information, and communicates with a server through a wireless network, the portable dashboard comprises a display unit displaying one or more statuses of the vehicle and a first communication unit transmitting a portable dashboard identification, the dashboard docking station comprises a second communication unit communicating with the first communication unit;
when the portable dashboard is coupled with the dashboard docking station:
enabling the second communication unit of the dashboard docking station to receive the portable dashboard identification;
determining the validity of the portable dashboard identification;
enabling an engine control module operating an engine of the vehicle when the portable dashsboard identification is valid;
when the portable dashboard is not coupled with the dashboard docking station:
determining a movement of the vehicle according to the movement information; and
enabling the observation module to transmit an exceptional movement warning message comprising the location information to the server in response to the movement of the vehicle.

12. The burglar proof method of claim 11, further comprising:
when the portable dashboard is coupled with the dashboard docking station:
enabling the observation module to transmit a validation failure warning message to the server when the portable dashboard identification is invalid.

13. The burglar proof method of claim 11, wherein the observation module comprises a data unit comprising parameters of the observation module, the observation module comprises a long distance wireless communication unit and a short distance wireless communication unit, the long distance wireless communication unit communicates with the server, the short distance wireless communication unit communicates with a portable device, the burglar proof method further comprising:
receiving an input for modifying the parameters of the observation module from the portable device; and
modifying the parameters of the observation module according to the input.

14. The burglar proof method of claim 11, further comprising:
detecting the removal of the portable dashboard from the dashboard docking station;
when the removal of the portable dashboard is detected:
enabling the engine control module to stop the engine; and
disabling the engine control module.

15. The burglar proof method of claim 11, further comprising:
receiving an engine stopping instruction from the server;
in response to receiving the engine stopping instruction:
enabling the engine control module to stop the engine of the vehicle; and
disabling the engine control module.

16. The burglar proof method of claim 15, wherein the portable dashboard further comprising an input unit, the burglar proof method further comprising:
receiving a password inputted through the input unit; and
enabling the engine control module when the password matches an unlock password.

17. The burglar proof method of claim 11, further comprising:
enabling the display unit of the portable dashboard to display the one or more statuses of the vehicle when the portable dashboard identification is valid; and
enabling the display unit of the portable dashboard not to display at least one of the statuses of the vehicle when the portable dashboard identification is invalid.

18. The burglar proof method of claim 11, wherein the one or more statuses of the vehicle includes at least one of speed, engine oil pressure, and accumulated mileage of the vehicle, the burglar proof method further comprising: enabling the display unit of the portable dashboard to display least one of the speed, the oil pressure, and the mileage when the portable dashboard identification is valid.

19. The burglar proof method of claim 11, wherein the first communication unit is a RFID (radio-frequency identification) reader, the second communication unit is a RFID chip comprising the portable dashboard identification, the step of “enabling the second communication unit of the dashboard docking station to receive the portable dashboard identification” comprises: enabling the RFID reader to receive the portable dashboard identification of the RFID chip.

20. The burglar proof method of claim 11, wherein the dashboard docking station further comprises a first power coil, the portable dashboard further comprises a second power coil, the burglar proof method further comprises: enabling the first power coil to provide power to the portable dashboard through the second power coil when the second power coil couples the first power coil.
